(19) United States
(12) Patent Application Publication
(10) Pub. No.: US 2021/0243202 A1
(43) Pub. Date: Aug. 5, 2021

(54) METHOD AND INTRUSION DETECTION UNIT FOR VERIFYING MESSAGE BEHAVIOR

(71) Applicant: Festo SE & Co. KG, Esslingen (DE)

(72) Inventors: Dominic Kraus, Stuttgart (DE); Lucian Bezler, Weilheim (DE)

(21) Appl. No.: 17/113,037

(22) Filed: Dec. 5, 2020

(30) Foreign Application Priority Data
Feb. 5, 2020 (DE) 10 2020 102 860.1

(51) Int. Cl. H04L 29/06; G05B 19/05; G05B 19/042; G06N 20/00

(52) U.S. Cl. CPC H04L 63/123; H04L 63/1416; G05B 2219/2642; G05B 19/042; G06N 20/00; G05B 19/05

(57) ABSTRACT

A method is provided for verifying a message behavior of a control unit for an automation system having a plurality of components, the control unit communicating with the components and the components communicating with each other via a communication network, with the steps being carried out on at least one component: receiving at least one message via the communication network, wherein the at least one message is provided by the controller analyzing the at least one received message according to a characteristic message description, and providing a verification message comprising a verification of the message behavior of the control unit as acceptable if the analyzed message matches the characteristic message description.

### CROSS REFERENCE TO RELATED APPLICATIONS

This application claims priority to German patent application DE 10 2020 102 860.1, filed Feb. 5, 2019, the entire content of which is incorporated herein by reference.

### TECHNICAL FIELD

The disclosure relates to a method for verifying a message behavior of a control unit (e.g., a programmable logic controller (PLC)) for an automation system, with a plurality of components, wherein the control unit is in data communication with the plurality of components and the components are in data communication with each other via a communication network. Furthermore, the disclosure concerns an intrusion detection unit (IDS) in a component of an automation system.

### BACKGROUND

In the times of the Internet of Things (IoT), machines are no longer operated in a completely encapsulated automation system but have communication connections to the outside world (outside the automation system or plant). These communication connections, if insufficiently secured, can serve as a so-called gateway to the machine, since 100% security cannot usually be guaranteed. Access to the machine is made possible via enabled network ports and common network protocols. The network protocols correspond to the current standards and the current state of IT security.

An inadequately secured network can lead to the fact that unauthorized third parties gain access to a machine master computer or a programmable logic controller, for example, in the automation system. Machine data can be read and/or manipulated unnoticed by the plant operator without his knowledge, so that individual machines—or in the worst case the entire automation plant—fails. An example of an unauthorized access which led to a manipulation of a system for monitoring and control is the computer worm “Stuxnet”. With this computer worm, machines of industrial plants were infected, and their function was disturbed or unauthorized data about the machines was collected and stolen for the purpose of damage.

The attack in question here, in particular the compromising of the automation system in the case of the computer worm “Stuxnet”, was successful from the point of view of the attackers, since no suitable means were available to detect the computer worm and/or the machines and/or the automation system compromised with the computer program. In particular it was not possible in the state of the art to verify the communication and thus the message behavior of the machines and/or the compromised machines for correctness.

Rockwell Automation's Factory Talk® Analytics approach is known for checking or “monitoring” the process data generated in a PLC environment. As a result, operating and maintenance problems can be identified and reduced. However, it is not possible to determine the target values and the commands provided by a PLC, nor to verify the actual values with an expected characteristic message description. Therefore, it cannot be determined whether there has been a manipulation of the provided target values.

From the WO 2015/104691 A2, an anomaly detection system is known to detect an anomaly in an industrial process plant. The anomaly detection system superordinate to the process plant comprises a data processing module with a training module and analysis module. The analysis module can be taught by training data and/or by analysis of the training module. The anomaly detection system can be trained via an initial training phase based on a safe industrial process plant. The training includes a classification of deviation so that the anomaly detection system can interpret which deviations from the correct data are acceptable and which are not acceptable.

From JP 2013/246531 A, a control unit with an error detection unit is known. The error detection unit comprises one model. The model is taught in a first mode of the error detection unit. Data about the normal operation are determined and taught. In a diagnostic mode it can be determined whether the data correspond to the learned data during the execution of the control program.

From WO 2018/166688 A2, the provisioning and execution of a machine taught model in field devices, especially in a programmable logic controller, is known. The model can be taught in a model learning environment.

These solutions provide for the control and detection of anomalies by a separate unit. In this respect, however, no consideration can be given to manipulation of this unit itself or it is not possible to detect manipulation from within the corresponding unit. Thus, also the control and the detection of anomalies can be compromised, which can lead to disturbances in the system to be monitored. This is especially the case if access to this unit by unknown third parties is already possible.

### SUMMARY

Therefore, there is a need for a mechanism for the autonomous and internal verification of a message behavior of a control unit for an automation plant. Based on the indicated related art and the resulting need, it is an object of the disclosure to provide a solution which at least partially overcomes the disadvantages known in the related art.

This object is achieved by a method for verifying a message behavior of a control unit for an automation system, an intrusion detection unit, an automation system, and a computer program as described herein.

According to a first aspect, the disclosure concerns a method for verifying a message behavior of a control unit for an automation system. The automation system comprises a plurality of components. The message behavior comprises control commands, in particular commands of the control unit to the plurality of components. The message behavior can comprise the exchanged messages (e.g., commands, control commands for the components and/or their response messages) as well as their time sequences and/or patterns and/or a message structure.

The term “message structure” here means metadata of the message or message sequence, such as its length, its repetition, its format, type, etc. Thus, there can be certain typical message patterns. In particular, the message behavior comprises the respective control commands for an operation of a corresponding component of the automation system. Further the message behavior can cover the appropriate accesses of the control unit to the components. The accesses cover here an operation-conditional and/or a time-conditional access. The control commands are provided as a bit sequence. The control unit can comprise a programmable logic controller as a single device (assembly). Furthermore, the control unit can be realized as a PC plug-in card in a personal computer or industrial PC connected to the automation system and/or as a software emulation (soft PLC). The control unit communicates with the components and the components communicate with each other via a communication network. The communication includes an exchange of data between the individual components and between the components and the control unit. The procedure includes the following steps, which are executed on at least one component: receiving at least one message via the communication network, said at least one message being provided by the control unit, analyzing the at least one received message according to a characteristic message description, and providing a verification message, comprising a verification of the message behavior of the control unit as acceptable if the analyzed message matches the characteristic message description. In other words, the verification message contains the result of the verification.

For the purposes of the present disclosure, a component is an actuator or a measuring sensor which can be used in an automation system. An automation system can be used in different areas, for example in the automotive, measurement technology or bio-laboratory sector. An automation system is a system in which complex and/or simple machines and/or technical components and systems perform activities, such as transport, production and/or measurement tasks, automatically and according to predefined instructions without human intervention. For this purpose, signals are acquired via measuring sensors and actuators are controlled.

The present disclosure is advantageous in that the actual communication of the control unit via the communication network and thus the sent messages are monitored and evaluated by at least one component of the automation system. The sent messages comprise commands for the components connected via the communication link. These commands represent a deterministic bit sequence, which is always structured in the same way for a command in a non-manipulated control unit. Also, a sequence of commands according to the respective operation (control task) is always the same. Both the bit sequence received by a component and a command sequence can be monitored. This makes it possible to detect a compromised control unit and thus to discard received commands from the compromised control unit. In addition, distributed monitoring and evaluation of the control unit can be performed by a large number of components of the automation system.

According to an exemplary embodiment of the disclosure, the verification message is provided to the control unit. The verification message comprises the result of the verification. Furthermore, the verification message may include the address and/or name of the component which provided the verification message. Based on the received message and a result of the verification, the verification message can be discarded in an advantageous way (e.g., due to stored exception rules). Alternatively, the component which provided the verification message can be assigned to a blacklist. The blacklist contains a list of components which are not classified as trustworthy and can be rejected in the future.

According to an exemplary embodiment of the disclosure, the verification message is provided to another component in the communication network. A component of the automation system, which does not itself provide the functionality to verify a message behavior, can thus be notified by the verification message about the admissibility of the message behavior of the control unit. This component can advantageously discard further received messages from the control unit. The technical and functional safety of the component and the automation system is increased in case of a compromised control unit.

Typically, message behavior analysis for compromise is performed locally and directly on the component.

According to an exemplary embodiment of the disclosure, the verification message is provided to another system. The further system can be designed as a control level for monitoring the automation plant. It should be noted that the control level is not designed to analyze or verify the message behavior but can only perform further processing of the behavior result.

The verification message can still be used to check and/or shut down the control unit. Based on the verification message, the control level can determine, for example, which component should be manipulated by the control unit. In addition, the further system can include another automation system, which are technically and/or functionally related. For example, an automation system for the production of an individual component can be connected to a higher-level automation system, which produces a final product from the individual component and other individual components.

According to another exemplary embodiment of the disclosure, the verification message is provided via an acyclic channel. The acyclic channel can be advantageously used as an additional or second channel in case the cyclic data (commands) of the control unit appear compromised. The acyclic channel can be used to transmit all non-real-time relevant data. Especially detailed error messages. These detailed error messages can be documented or provided with a time stamp. The acyclic channel can also be used if no independent action is desired by the component and should be triggered, but this should be actively confirmed by the user in a control level.

According to another exemplary embodiment of the disclosure, providing the verification message includes providing a control signal to the control unit. The control signal may include a signal for switching the operating state of the control unit to a stop state. Thus, a further spread of manipulation in the automation system via the communication network can be stopped efficiently. In addition, the control unit can be set to a secured state in which the manipulation can be detected and cleaned up. Alternatively, the control unit can be put into a reset state, in which the firmware of the control unit and/or the control program of the automation system is reset to a last known and safe state of the firmware and the control program.

According to another exemplary embodiment of the disclosure, providing the verification message comprises providing a control signal to another component. Via the control signal a further component, which does not itself provide the functionality for verifying a message behavior, can be controlled in such a way that it does not accept any further messages of the control unit and/or rejects them, if the message behavior with respect to the further component is evaluated as “compromised” by another component with verification functionality. Compromising and/or damaging of the further component by wrong and/or faulty commands of the control unit is avoided (external protection).

According to another exemplary embodiment of the disclosure, providing the verification message comprises providing a control signal to another system. The control signal can be used to control the further system in such a way that it minimizes or stops communication to the automation system with the compromised control unit, for example, in order to prevent the damage from spreading.

According to a further exemplary embodiment of the disclosure, the control signal comprises a restriction or deactivation of a functionality of the component. The functionality of the component can be restricted so that, for example, no safety-relevant functions are executed. Alternatively, functions of the component can be switched off or deactivated as long as the control signal is present.

According to a further exemplary embodiment of the disclosure, the control signal comprises a restriction or switch-off of a functionality of the control unit. Thus, the propagation and spreading of the manipulation to further components of the automation system can be limited or prevented in an advantageous way. Furthermore, in this state the correct function of the component can be checked by the control level.

According to a further exemplary embodiment of the disclosure, the control signal comprises a restriction or switch-off of a functionality of the further system. This is an advantageous way to prevent the propagation and spreading of the manipulation to the further system or damage.

According to a further exemplary embodiment of the disclosure, the provision of the verification message occurs if a plurality of the components of the communication network verify the message behavior of the control unit as not permissible. In a favorable way, restrictions in the function and/or deactivation of the automation system and/or a further component due to a faulty verification result indicating a compromising (false positive) can thus be avoided. In particular, the verification message can remain unconsidered if a prescribed and/or fixed number of components of the automation system do not provide this verification message (majority decision). In a further exemplary embodiment, the verification message can remain unconsidered, if not a prescribed and/or specified combination of components of the automation system provide the same verification message. In particular, a distinction can be made between critical and non-critical components of the automation system. This can be defined by a valence or significance factor. For example, the verification message of a critical component of the automation system can lead to the complete provision of the same but can contain restrictions for the other components of the automation system, the further system and/or for the control unit.

According to a further exemplary embodiment of the disclosure, the provision of the verification message occurs if 25% of the plurality of components, typically 51% of the plurality of components, particularly typically 75% of the plurality of components of the communication network or the automation system verify the message behavior of the control unit as not admissible. In an advantageous way, the verification message is provided to the control unit and/or further systems and/or components of the automation system only if a corresponding number of components also verify the message behavior of the control unit as not allowed. The higher the number of components providing the verification message, the higher is the degree of correct verification. Thus, the rate of false messages can be minimized. For example, a false message is a message when there is a minor anomaly in the message behavior.

In another version of the disclosure, the verification message is provided by a user-defined threshold value and/or warnings. This depends on the number of components in the automation system that support this function. In most cases, an attack can be targeted to a single critical component. This attack can be detected in an advantageous way by the other components of the automation system.

According to a further exemplary embodiment of the disclosure, the characteristic message description comprises an error-free and/or trustworthy message behavior between the control unit and the component. The error-free and/or trustworthy message behavior can be determined quasi as reference message behavior in a secured environment. Furthermore, the error-free and/or trustworthy message behavior can be determined in an active automation system in which there is a high probability that no compromising is present. The error-free and/or trustworthy message behavior can include the correct messages (commands) of the control unit for controlling the components. A correct message is the correct command in the corresponding bit sequence, a correct sequence of successive commands and/or a correct time interval between successive commands. In addition, the trusted message behavior can also include the component's response to the received message. An incorrect and/or unexpected response may include an erroneous and/or untrusted message behavior.

According to a further exemplary embodiment of the disclosure, the method comprises the step of providing at least one response message by the at least one component to the controller as a result of the at least one received message. The response message corresponds to a feedback and/or the reaction of the component to the received message. The response may include the operation of the component.

According to a further exemplary embodiment of the disclosure, the characteristic message description comprises a time duration, which comprises the time between the receipt of the message on the component and the provision of the response message and/or a conversion (or execution) of a command contained in the message on the component. The time required for message processing and/or execution of the commands contained in the message can be determined in an advantageous way. The execution of an operation and thus the provision of the response message based on a message from the control unit is deterministic and follows the same pattern. By knowing the necessary time, deviations can be detected and analyzed. These deviations can include manipulations of the commands and/or accesses of the control unit.

According to another exemplary embodiment of the disclosure, the characteristic message description is trained in a model. In a program for the control unit, in particular a programmable logic controller, the sequence of commands for the respective components is programmed deterministically. The sequence of the commands is sent as a bit sequence over the communication link, for example a field bus. A component, the control unit and/or a further system can take up this bit sequence and build a decision tree or a neural network from it. This results in probabilities for the “normal” bit sequences. The “normal” bit sequence describes the bit sequence which is sent by a non-compromised control unit. When a component now receives a command (via message in a bit sequence), it knows by the probabilities in the decision tree or neural network what the other bits in the command chain should be like. If deviations (“Unlikely/Unexpected Event”) and/or irregularities occur during transmission, these can be detected and a corresponding verification message “Anomaly detected” can be provided.

According to another exemplary embodiment of the disclosure, the model is taught via a graphical decision tree. Here the decision tree can be an ordered and/or directed tree with the help of which decision rules can be represented. Hierarchically successive decisions can be defined via the graphically representable tree.

According to another exemplary embodiment of the disclosure, the model is taught via a neural network. The neural network is designed in such a way that new knowledge can be generated from already collected experiences. The neural network is trained from a collected message behavior in order to generalize the message behavior after completion of a learning phase. The neural network is thus based on the collected experiences as training data. Thus, patterns and regularities in the training data are recognized. The neural network is trained by the message behavior between a component and the control unit. The message behavior can also include corresponding response messages. A neural network is a network consisting of artificial neurons which are interconnected. The architecture and topology of the neural network depends on the intended task. The network is used to exchange messages between the respective nodes. The connections have numerical weightings, which can be adapted based on experience and thus make the neural network adaptable to the input and capable of learning. The neural network can be learned by developing new connections between the neurons, deleting existing connections between the neurons, changing the weighting from neuron to neuron, adding or deleting neurons, and possibly adjusting the threshold values of the neurons. Via the neural network, frequently recurring patterns in the message behavior are identified. Furthermore, the bit sequence of the commands in the message behavior and the duration of the transmission can be identified. In an advantageous form of execution, the neural network can be trained with the message behavior between a neighboring component and the control unit. In an advantageous way, the messages provided by a control unit to a component and/or neighboring components, e.g., commands, can be verified for correctness.

The neural network can be designed as a Deep Neural Network and can include in particular a Convolutional Neural Network and/or a Deep Feed Forward Network. A Deep Neural Network is a neural network with a certain complexity, which consists of at least two layers, typically more than two layers. Deep Neural Networks use a mathematical model to process data in a complex way. Deep neural networks are trained for a specific technical task, such as pattern recognition of anomalies in message behavior. A Convolutional Neural Network (CNN) is a multi-layer processing unit that includes folding, pooling and rectified linear units (ReLU layers). These layers can be arranged in any order as long as they meet the criteria of input size and output size.

According to another exemplary embodiment of the disclosure, the model is taught on the component. According to a further exemplary embodiment of the disclosure, the model is taught on the control unit. According to a further exemplary embodiment of the disclosure, the model is taught on a separate unit. The model can be taught by any electronic unit of the automation system whose resources are trained to teach a model and which can access the communication network. Thus, no additional hardware and/or software is required for the teach-in process. The communication network can be accessed via a LAN connection, a serial connection and/or a wireless connection.

According to a further exemplary embodiment of the disclosure, the model is stored locally in the component or in selected components. The component may have one or more processors and a memory, which are adapted to perform the process according to the disclosure. Furthermore, an intrusion detection unit may be formed in the component. In particular, the component may have different types of memory, for example, a volatile and/or a non-volatile memory. In the memory of the component the model for the verification of the message behavior is stored. In the model the characteristic message description is learned. The decentralized storage of the model and the resulting monitoring across several components enables the safe detection and reporting of unauthorized manipulation of the control unit (comparison of the verification results of several components).

According to a further exemplary embodiment of the disclosure, the model must be trained to the message behavior of the component in which the model is stored. Alternatively or cumulatively, the model can be trained to the message behavior of a component which is placed adjacent to the component storing the model. According to a further exemplary embodiment of the disclosure, the verification procedure is provisionally executed for an adjacent component and its messages. In an advantageous way, the messages sent from the control unit to a component via the communication network are received and/or read by all components of the automation system. Since the addresses of the respective components lying before and after in the address range are known for a respective component, the messages (commands) to be received can also be taught in the model and the message behavior can be verified. This is especially advantageous if components do not have the necessary hardware and/or software resources to execute the model and verify the message behavior. Thus, protection against abnormal command behavior and/or abnormal access by the control unit can be provided for these (lean) components.

According to a second aspect, the disclosure relates to an intrusion detection unit in a component of an automation system, wherein the components of the automation system communicate with each other and with a control unit via a communication network, and wherein the intrusion detection unit is designed for locally verifying a message behavior of the control unit, with: a receiving unit adapted to receive at least one message from the control unit via the communication network for the purpose of controlling the component, an analysis interface to an analysis unit adapted to analyze the at least one received message according to a characteristic message description stored in a component memory, and a verification interface to a verification unit which is designed to verify the message behavior of the control unit as acceptable if the analysis message corresponds to the characteristic message description.

The intrusion detection unit can be implemented as a separate unit in the component. In a further exemplary embodiment, the intrusion unit can be implemented in an existing microcontroller of the component. Furthermore, the intrusion detection unit can be implemented in hardware on an integrated circuit (IC). The functions of the analysis unit and the verification unit can be combined in a common unit with an interface, if for example only one component is designed with the intrusion detection functionality. The design of the analysis unit and the verification unit in two separate units has the advantage in this respect, that if only one component of the automation system has the computing resources to completely evaluate a decision tree, the other components of the automation system can take over the evaluation of the chain of command or parts of the decision tree. Thus, the analysis and verification of available resources can be distributed.

According to an exemplary embodiment of the second aspect of the disclosure, the intrusion detection unit comprises a transmission unit adapted to provide at least one response message as a result of the at least one received message.

According to another exemplary embodiment of the second aspect of the disclosure, the intrusion detection unit has an output unit which is designed to output a verification message provided by the verification unit. The response message corresponds to a feedback and/or the reaction of the component to the received message. The response may include the operation of the component.

In accordance with another exemplary embodiment of the second aspect of the disclosure, the intrusion detection unit has an input unit adapted to receive a control signal for disabling the verification of the message behavior of the control unit. In a beneficial manner, the verification of the message behavior can be deactivated in case of maintenance of the automation system and/or the control unit, which can represent an abnormal behavior. This can be done for example by a user with a password entry via an operator terminal or via a switch unit of the automation system or the control unit.

According to a third aspect, the disclosure relates to an automation system with a plurality of components controlled by a control unit and communicating with it via a communication network, all or selected components comprising an intrusion detection unit.

The above-described, exemplary embodiments of the method for verifying a message behavior can also be designed as a computer program, whereby a component is caused to carry out the above-described, inventive method if the computer program is executed on the component or on a processor or microcontroller of the component. The computer program may be provided by download or stored in a memory unit of the component with computer-readable program code contained therein to cause the intrusion detection unit to execute instructions according to the above-mentioned procedure.

It is within the scope of the disclosure that not all steps of the method necessarily have to be performed on one and the same component, but they can also be performed on different components.

In addition, it is possible that a single section of the method described above can be carried out in one saleable unit and the remaining sections in another saleable unit—as a distributed system, so to speak. In particular, it is possible to perform the method step of receiving a message in a first component and analyzing the message and providing a verification message in a second and/or further component.

The above-mentioned arrangements and further exemplary embodiments can be combined with each other as far as reasonable. In particular, the features of the method claims can be realized as structural features in the intrusion detection unit. Further possible designs, further training and implementations of the disclosure also include combinations of features of the disclosure described before or in the following regarding the examples of execution, which are not explicitly mentioned. In particular, the skilled person will also add individual aspects as improvements or additions to the respective basic form of the present disclosure.

### BRIEF DESCRIPTION OF THE DRAWINGS

The disclosure will now be described with reference to the drawings wherein:

FIG. 1 shows a schematic view of a design of the automation system according to an exemplary embodiment of the disclosure,

FIG. 2 shows a schematic view of the automation system according to another exemplary embodiment of the disclosure,

FIG. 3 shows a flow chart of a method according to an exemplary embodiment of the disclosure,

FIG. 4 shows a schematic view of a component according to an exemplary embodiment of the disclosure,

FIG. 5 shows a schematic view of the component according to a further exemplary embodiment of the disclosure,

FIG. 6 shows a schematic view of the structure of a graphical decision tree according to an exemplary embodiment of the disclosure, and

FIG. 7 shows a schematic view of the learning of a neural network according to an exemplary embodiment of the disclosure.

### DESCRIPTION OF EXEMPLARY EMBODIMENTS

In the following detailed description of the figures, non-restrictive design examples are discussed with their characteristics and further advantages based on the drawing.

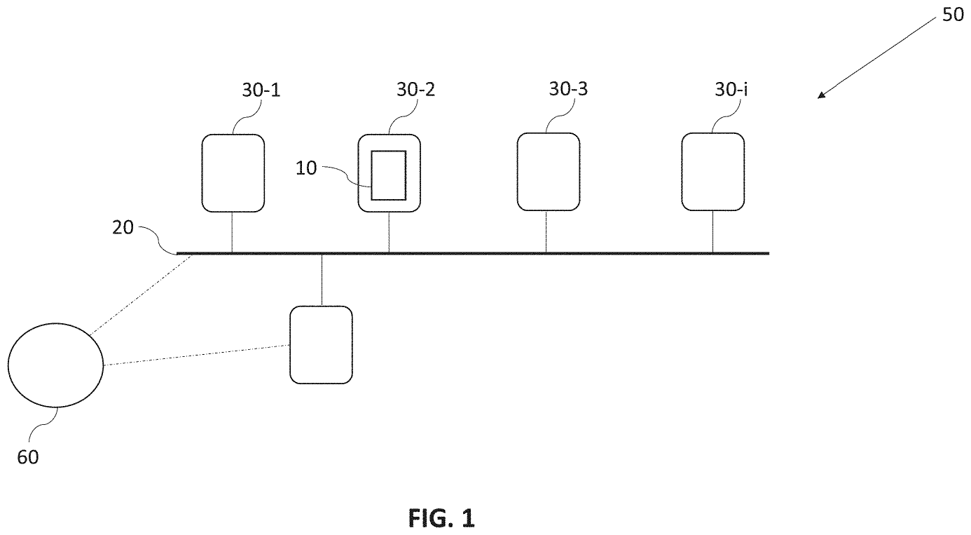

FIG. 1 shows a schematic view of a design of the automation system according to an exemplary embodiment of the disclosure. In FIG. 1, reference number 50 indicates an automation system. The automation system 50 comprises a variety of components 30-1 to 30-i. The components 30-1 to 30-i of the automation system 50 communicate with each other via a communication network 20 and/or via the communication network 20 with a control unit 40. The components 30-i are electronic devices, e.g., an actuator or a sensor. The components 30-i have a communication interface for connecting to the communication network 20. The communication network 20 of FIG. 1 includes a bus topology. In the bus topology, all components 30-1 to 30-i are connected to a common transmission medium. The communication network 20 can be designed as a LAN network. Furthermore, a connection can be established by appropriate gateways via a serial connection or via a WLAN connection. Each of the components 30-1 to 30-i can communicate freely with any other component 30-1 to 30i. In an advantageous way, no master station is required to control the communication in the communication network 20. The messages transmitted via the communication network with a bus topology from the Control Unit to the components 30-1 to 30-i are received by all components 30-1 to 30-i connected to the communication network 20. Thus, for example, messages intended for component 30-1 and/or component 30-2 can also be received by a component 30-2—on a provisional basis, so to speak. This data not intended for component 30-1 can be analyzed but does not necessarily have to be evaluated for conversion in component 30-1. For this purpose, a broadcast is used in which all data packets are transmitted from control unit 40 to all components 30-1 to 30-i of automation system 50. A broadcast packet reaches all components 30-1 to 30-i of the communication network 20 without being explicitly specified as receiver. Each component 30-1 to 30-i of a broadcast decides for itself whether it will either process the received message in case of a responsibility or otherwise tacitly discard it.

In FIG. 1, component 30-2 includes an intrusion detection unit 10 for local verification of a message behavior of control unit 40. The intrusion detection unit 10 includes a receiving unit 11 (cf. 4). The receiving unit 11 is designed to receive at least one message from the control unit 40 via the communication network 20 for the purpose of controlling the component 30. Furthermore, the intrusion detection unit 10 comprises an analysis interface 12 to an analysis unit 13. The analysis unit 13 is designed to analyze at least one received message according to a characteristic message description stored in a component memory. The characteristic message description is taught in a model. In addition, the intrusion detection unit 10 comprises a verification interface 14 to a verification unit 15. The verification unit 15 is designed to verify the message behavior of the control unit 40 as permissible if the analysis message corresponds to the characteristic message description.

Components 30-1 to 30-i can store or access the learned model locally. The learned model can be trained using a graphical decision tree and/or a neural network. The recurring program sequence of the control unit 40 with the deterministic messages can be taught to the components 30-1 to 30-i via the graphical decision tree and/or the neural network. Also, the address range of those components can be learned, which is not relevant for the actual component. The learning of the characteristic message description in a model can be done on the control unit 40, on another system 60, for example an industrial PC or server, which communicate with the communication network 20 and/or on the component 30-1 to 30-i. The application of the trained model and thus the verification of the message behavior is performed on at least one component of the plurality of components 30-1 to 30-i of the automation system 50.

The message behavior describes the messages which are sent from a control unit 40 via the communication network 40 to the components 30-1 to 30-i. The messages can be damaged and/or manipulated by compromising the control unit, which can also cause the component 30-1 to 30-i to perform an unexpected reaction and/or damage and/or damage the automation system 50 or restrict its function. A trustworthy message behavior, which is verified as permissible by one of the components 30-1 to 30-i, includes messages or commands of the control unit 40, which are stored in a correct sequence of consecutive commands and/or a correct time interval between consecutive commands. In addition, the trusted message behavior may also include the component's response to the received message.

Since, in principle, components 30-1 to 30-i receive all messages sent via the communication network 20 in an advantageous way, component 30-2, for example, can also learn the message behavior and/or commands for the neighboring component 30-1 and/or the neighboring component 30-3 in a model to be stored locally. The selection of component 30-3 is only exemplary and does not represent a restriction for the disclosure. Rather, the automation system 50 can include further components 30-i, which store a model that has been taught to a message behavior for other components 30-i. Also, the arrangement of the components 30-1 to 30-i shown in FIG. 1 and the designation as adjacent and/or previous and/or subsequent component 30-i is an exemplary arrangement. A neighboring component 30-i can also comprise a neighboring address range but may be located locally away in the automation system 50. In one version the components 30-1 to 30-i are controlled by a fixed address designation by the control unit 40, for example by a programmable logic controller.

In the version shown in FIG. 1, the message behavior of component 30-1 and component 30-3 can be taught in the model of component 30-2. This is advantageous if component 30-1 and component 30-3 do not have the corresponding resources (computing power, storage capacity, energy, etc.) available to implement the program for verifying a message behavior and/or the units of the intrusion detection unit 10. It is advantageous to verify the admissibility of the messages sent by the control unit 40 to component 30-1 and component 30-3 via component 30-2. This protects the components against manipulation and/or damage by messages sent by a compromised control unit 40. Another advantage is that each component 30-i can be protected against attacks. If attacks on individual components are initiated, this is detected by a compromised control unit 40 and measures can be taken. Each component 30-i can thus actively or passively (as the selected target of the manipulation) detect abnormal command behavior and/or abnormal accesses of the control unit. An action can provide feedback to a user and/or to a control level. This can be done via an acyclic channel. Furthermore, the verification message can provide a control signal, a restriction and/or shutdown of a functionality of a component 30-1 to 30-i and/or the control unit 40 and/or a further system 60.

In order to minimize the rate of false alarms, in particular to minimize a malfunction and/or standstill of the automation system due to false alarms, a so-called majority decision of components 30-1 to 30-i can be implemented. The majority decision can include a defined number of components 30-1 to 30-i of the automation system 50. In an execution form, the verification message, comprising a control signal, is provided if 25% of the components 30-i, typically 51% of the components 30-i, particularly typically 75% of the components 30-i of the communication network 20 or the automation system 50 verify the message behavior of the control unit 40 as not permissible. The rate of false messages is minimized the more components 30-i are considered for the verification of the message behavior.

In a further exemplary embodiment, only preconfigured components can be designed with the intrusion detection unit 10. The selection of the components 30-i depends on the importance for the function of the automation system 50 or on the level. For example, an intrusion detection unit 10 can be provided for a critical component 30-1, 30-2, 30-3, while for another component 30- i the impairment for functions of this component and/or the entire automation system 50 would be negligible. In this way, the functions of the components and/or the automation system can be maintained until a critical level is reached.

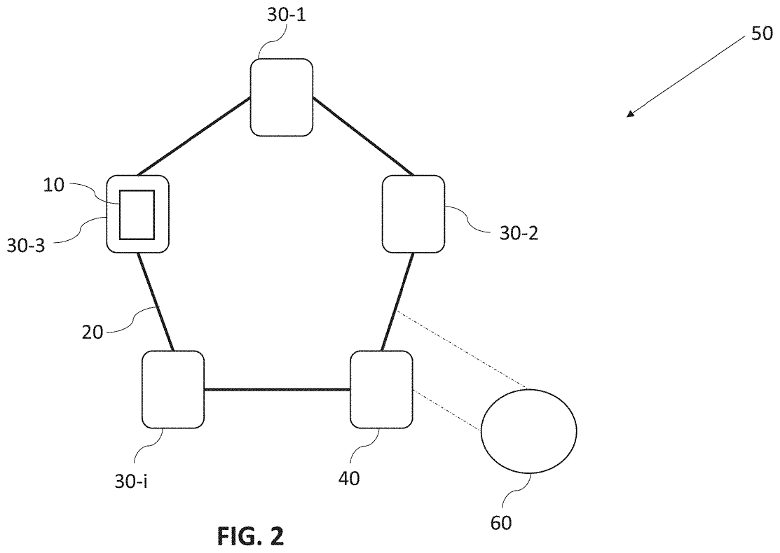

FIG. 2 shows a schematic view of the automation system 50 according to another exemplary embodiment of the disclosure. The automation system 50 as shown in FIG. 2 comprises the components 30-1 to 30-i and a control unit 40. The components 30-1 to 30-i and the control unit 40 are connected to each other via a communication network 20. The communication network 20 of FIG. 2 is designed as a ring topology and represents the common transmission medium. The ring topology represents a closed transmission medium. The components 30-1 to 30-i hanging in the communication network 20 are an integral part of the transmission medium. Each of the components 30-1 to 30-i has a unique predecessor and a unique successor. The messages to be transmitted are transferred from one component 30-i to the other component 30-i. Each 30-i component tests whether the message is intended for it. If the message is not intended for this component 30-i, the message is forwarded to the next component 30-i. If the message is intended for this component 30-i, it is used by this component 30-i or the command is implemented by the component 30-i.

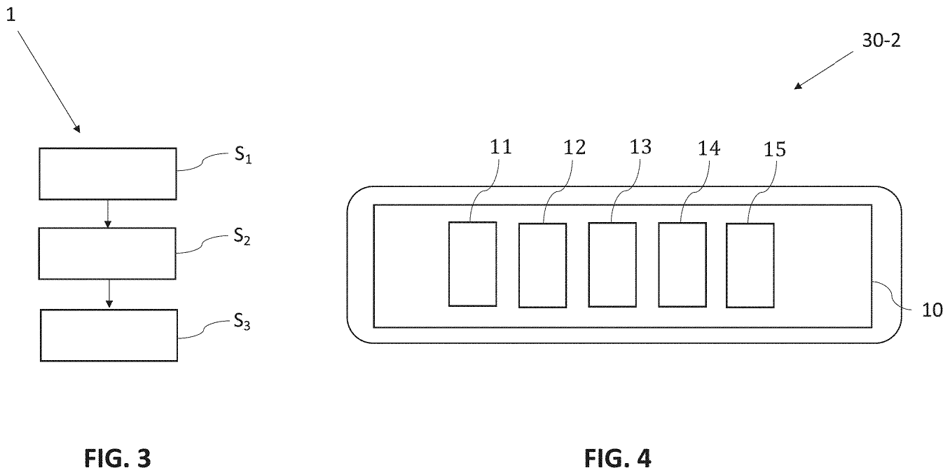

FIG. 3 shows a flow chart according to an exemplary embodiment of the inventive step. Method 1 comprises several steps for the design shown. In a first step S1 at least one message is received via the communication network 20. The at least one received message is provided by the control unit 40. In a second step the at least one received message is analyzed according to a characteristic message description. In a third step S3 a verification message is provided, comprising a verification of the message behavior of the control unit 40 as permissible, if the analyzed message corresponds to the characteristic message description.

FIG. 4 shows a schematic view of component 30-2 according to an exemplary embodiment of the disclosure. In FIG. 4, reference sign 10 designates an intrusion detection unit that is implemented in component 30-2 of an automation system 50 (cf. FIG. 1). The intrusion detection unit 10 is designed for local verification of a message behavior of the control unit 40. The intrusion detection unit 10 comprises a receiving unit 11 which is designed to receive at least one message from the control unit 40 via the communication network 20 for the purpose of controlling the component 30-2. The message comprises the setpoints of the control unit 40, for example of a programmable logic controller, which comprise the commands for actuating and/or controlling the component 30-2. The message is transmitted as a bit sequence via the communication network 20. In a non-compromised system, if the message behavior has been verified as permissible, actual values, so-called feedback messages, can be transmitted by component 30-2. The intrusion detection unit 10 also includes an analysis interface 12 to an analysis unit 13, which is designed to analyze at least one received message according to a characteristic message description stored in a component memory. In addition, the intrusion detection unit 10 comprises a verification interface 14 to a verification unit 15. The verification unit 15 is designed to verify the message behavior of the control unit 40 as permissible if the analysis message corresponds to the characteristic message description. The analysis unit 13 and the verification unit 15 can be implemented as one unit on a component 30-2 or as separate units on a component 30-2 or on two different components 30-i. Implementing them separately allows verification to be performed even if not enough resources can be provided in a single component 30-i.

The intrusion detection unit is advantageously implemented as a decentralized system in several components 30-i of the automation system 50. This increases the security and the degree of difficulty to manipulate the system. A compromise is detected, and countermeasures can be initiated and further manipulations and/or malfunctions and/or data theft can be excluded. Due to the decentralized implementation on a plurality of components 30-i in an automation system 50, the effort and/or the degree of difficulty is very high to manipulate all components in such a way, especially to manipulate them simultaneously, so that an attack and/or manipulation by the intrusion detection unit remains unnoticed. In addition, components 30-i, which cannot protect themselves, are protected by the components with an intrusion detection unit. An attempt at manipulation can be detected and repelled accordingly.

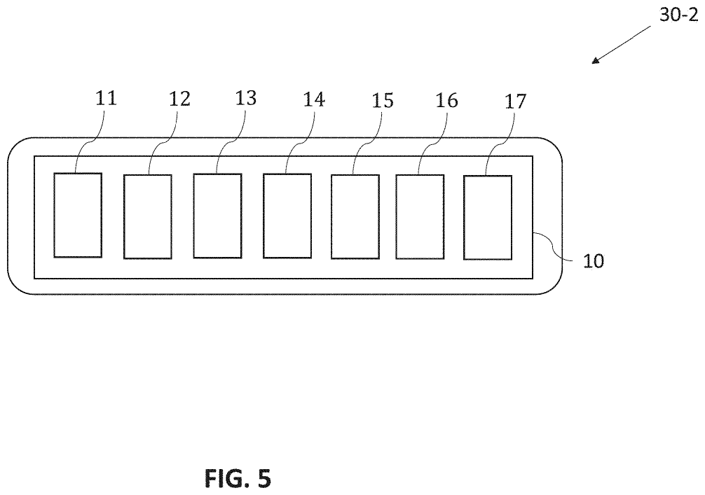

FIG. 5 shows a schematic view of the component 30 according to a further exemplary embodiment of the disclosure. The intrusion detection unit 10 according to the exemplary embodiment shown in FIG. 5 comprises the units of the embodiment shown in FIG. 4. Additionally, the intrusion detection unit 10 comprises an output unit 16. The output unit 16 is designed to output the verification message provided by the verification unit 15. Furthermore, the intrusion detection unit 10 comprises an input unit 17. The input unit 19 is designed to receive a control signal to switch off the verification of the message behavior of the control unit 40. The control signal can deactivate the verification and the provision of a verification message especially in case of a maintenance case, which also represents an abnormal behavior. This can minimize the number of false messages.

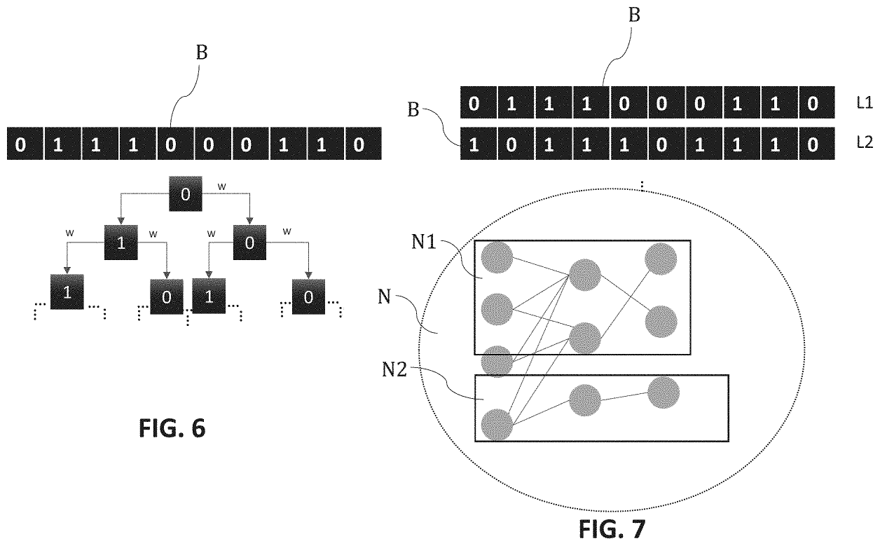

FIG. 6 shows a schematic view of the structure of a graphical decision tree according to an exemplary embodiment of the disclosure. The model of the present disclosure is taught via a graphical decision tree. The decision tree can be an ordered and/or directed tree. With the help of the ordered and/or directed tree, decision rules can be represented. In particular, hierarchically successive decisions can be defined via the graphically representable tree. In an execution form, only one bit sequence B of a command is considered. Here the ordered and/or directed tree is built purely from the bit sequence B. The first bit contains a logical “0” bit. Via the edges the corresponding probability W can be defined that the first bit with the logical “0” is followed by a bit with logical “0” or “1”.

If the components always see the same bit sequence B, the ordered and/or directed tree is deterministic. In a further execution form, response options in the return channel can be considered. Thus, a more complex tree can be formed. Thus, with a certain probability a corresponding response to a special command is expected, and to a corresponding response a suitable command is expected. It can be differentiated whether the answer to a command does not fit to the expectation. For example, if only a minor violation of the message behavior was detected, this may have been influenced by the direct environment. However, if the expected subsequent command does not match the previously sent response, this corresponds to a high-level violation and would thus be detected as an unexpected new command and thus as a manipulation of normal behavior.

FIG. 7 shows a schematic view of the learning of a neural network according to an exemplary embodiment of the disclosure. Neural networks can be used in more complex systems where a large number of unknown dependencies are present. A labelled data set of sufficient size is required for the learning process and the neural network must be trained on a powerful computing unit. Sufficient size means that enough data sets with corresponding labels are available to establish appropriate relationships and to teach decision criteria or to cover alternatives. The computing unit can be designed as a stand-alone PC, as a combination of a plurality of PCs in hardware and/or virtualized. The neural network can be applied to one or a plurality of components. The data set for learning the neural network N is the command and response sequence in the communication channel. The upper levels of the network could represent the individual components and their functions or relate them to each other. This would have the advantage that it might not be necessary to store the whole neural network N on a component 30-i, but only the part that becomes relevant for it. Alternatively, the neural network N can be distributed completely or in parts to all components 30-i that execute parts of it, which means that components 30-i can also be monitored by the network without the corresponding resources. In FIG. 7, two different bit sequences B are shown. The different bit sequences B can be identified for example with a label L1 and L2. In FIG. 7 the reference sign N designates the neural network, which was created for example from bit sequences B and corresponding labels L1 and L2. In one version, the neural network N can be completely distributed for use on one or all components 30-i of the automation system 50. In another version, only one specific power supply N1 of the neural network N can be relevant for a component 30-i. Only the power supply N1 is applied to this component 30-i. For another component 30-i or further components 30-i, for example, the power supply N2 is relevant. Thus, it can be planned to apply only this power supply N2 to the corresponding components 30-i.

In conclusion, it should be noted that the description of the disclosure and the examples of execution are basically not to be understood as restricting with regard to a certain physical realization of the disclosure. All features explained and shown in connection with individual embodiments of the disclosure may be provided in different combinations in the subject matter of the disclosure in order to realize its advantageous effects at the same time.

The scope of protection of the present disclosure is given by the claims and is not limited by the features explained in the description or shown to the figures.

### LIST OF REFERENCE NUMERALS

1 Procedure
10 Intrusion detection unit
11 Receiving unit
12 Analysis interface
13 Analysis unit
14 Verification interface
15 Verification Unit
16 Output unit
17 Input unit
20 Communication network
30-1, 30-2, 30-3 Component
30-i Large number of components/components
40 Control unit
50 Automation plant
60 additional system
B Bit sequence
N neural network
N1, N2 Subnets of the neural network
S1 to S4 Process steps
W Probability

What is claimed is:

1. A method for verifying a message behavior of a control unit for an automation system having a plurality of components, the control unit communicating with the components and the components communicating with one another via a communication network, the method comprising the steps which are carried out on at least one component:
receiving at least one message via the communication network, in particular from the control unit;
analyzing the at least one received message according to a characteristic message description; and
providing a verification message comprising a verification of the message behavior as acceptable if the analyzed message matches the characteristic message description.

2. The method according to claim 1, wherein the verification message is provided to the control unit and/or to a further component in the communication network and/or to a further system.

3. The method according to claim 1, wherein the provision of the verification message is done via an acyclic channel.

4. The method according to claim 1, wherein providing the verification message comprises providing a control signal to the control unit and/or to a further component and/or a further system.

5. The method according to claim 4, wherein the control signal comprises restricting or switching off a functionality of the component and/or the control unit and/or the further system.

6. The method according to claim 1, wherein providing the verification message is carried out if a plurality of the components of the communication network verify the message behavior of the control unit as not permissible.

7. The method according to claim 1, wherein the characteristic message description comprises an error-free and/or trustworthy message behavior between the control unit and the component.

8. The method according to claim 1, further comprising:
providing at least one response message by said at least one component to said control unit as a result of said at least one received message.

9. The method according to claim 1, wherein the characteristic message description comprises a time period which comprises the time between receipt of the message and providing of the at least one response message on the component and/or a conversion of a command contained in the message on the component.

10. The method according to claim 1, wherein the characteristic message description is learned in a model.

11. The method according to claim 10, wherein the model is learned via a graphical decision tree and/or a neural network.

12. The method according to claim 10, wherein the learning of the model is performed on the component and/or the control unit and/or a further system.

13. The method according to claim 10, wherein the model is stored in the component.

14. The method according to claim 10, wherein the model is trained on the message behavior of the component in which the model is stored and/or wherein the model is trained on the message behavior of a component placed adjacent to the component storing the model.

15. The method according to claim 1, wherein the method for verifying is provisionally executed for an adjacent component and its messages

16. An intrusion detection unit in a component of an automation system, wherein the components of the automation system communicate with one another and with a control unit via a communication network, and wherein the intrusion detection unit is designed to verify a message behavior of the control unit locally, the intrusion detection unit comprising:
a receiving unit adapted to receive at least one message via the communication network for the purpose of controlling the component;
an analysis interface to an analysis unit adapted to analyze the at least one received message according to a characteristic message description stored in a component memory; and
a verification interface to a verification unit which is adapted to verify the message behavior as permissible if the analysis message corresponds to the characteristic message description.

17. The intrusion detection unit according to claim 16, further comprising:
an output unit adapted to output a verification message, the verification message being provided by the verification unit.

18. The intrusion detection unit according to claim 16, further comprising:
an input unit adapted to receive a control signal for disabling the verification of the message behavior of the control unit.

19. An automation system comprising:
a plurality of components driven by a control unit and communicating therewith via a communication network, wherein all or selected components comprise an intrusion detection unit according to claim 16.

20. A computer program with program code for executing the method according to claim 1, when the computer program is executed on a component.
